(19) United States
(12) Patent Application Publication
(10) Pub. No.: US 2005/0252058 A1
(43) Pub. Date: Nov. 17, 2005

(54) COMPOSITE ART WORK AND PROCESS FOR PRODUCING THE SAME

(75) Inventors: Aharon Shaked, Lod (IL); Amos Avraham, Lod (IL)

Correspondence Address: MARSTELLER & ASSOCIATES, P O BOX 803302, DALLAS, TX, 75380-3302, US

(73) Assignee: ASPAKLARIA IMPORT/EXPORT AND MARKETING PICTURE FRA, Rishon Lezion (IL)

(21) Appl. No.: 10/708,956

(22) Filed: Apr. 2, 2004

(51) Int. Cl. G09B 19/22

(52) U.S. Cl. 40/798

(57) ABSTRACT

A composite art work and a process for producing the same are disclosed. The art work comprises a representation adhesively affixed to a relatively smooth backing and an artistic frame contiguous with the representation. At least a portion of the frame is produced from a forming medium applied to the backing such that edges of the representation are substantially indistinguishable from an art form produced from said forming medium.

### BACKGROUND OF INVENTION

1. Field of the Invention

The present invention relates to the field of artistic articles. More particularly, the invention relates to a composite art work made from a representation and a surrounding formable frame.

2. Background of the Invention

Frames are used for protecting the sides of a painting and for facilitating its hanging on a wall in a vertical disposition, in order to provide a desired effect to an observer. For example, fresco painting has been utilized for centuries to obtain a fresco finish characterized by a marble-like appearance. A thin layer of mineral colors are applied to freshly laid lime plaster, such that the pigments of the applied colors are absorbed into the plaster by capillary action and become an integral part of the newly formed surface. However, the frame in which a fresco-finished painting is mounted is separate from, and generally different in appearance than, the centrally mounted painting.

Decorative frames may be produced from a material or color similar to, or complementary with, that of the painting. Nevertheless, the frame does not blend in with the painting to form a continuous work of art, but rather it remains a noticeably separate object thereto. At times, the frame is inconsonant with the artistic effect provided by the painting. Furthermore, the cost of a frame relative to the painting is significant, considerably adding to the cost of purchasing an art work.

It is an object of the present invention to provide an artistic frame that blends in with the painting mounted thereby to form a continuous work of art.

It is an additional object of the present invention to provide an artistic frame that is made from inexpensive and commonly found materials.

It is an object of the present invention to provide an artistic frame that complements the centrally mounted painting such that an optical effect is produced that is not found in prior art works of art.

Other objects and advantages of the invention will become apparent as the description proceeds.

### SUMMARY OF INVENTION

The present invention provides a composite art work comprising a representation adhesively affixed to a relatively smooth backing and an artistic frame contiguous with the representation, at least a portion of said frame being produced from a forming medium applied to the backing such that edges of the representation are substantially indistinguishable from an art form produced from said forming medium.

The term “representation,” as referred to herein means an art form, such as a reproduction, print, film, lithograph, printed fabric, sculpture, or an original painting, a naturally found object, such as a leaf or flower, an industrially produced object, such as glass, a tile, mirror or a mosaic, or any hand-made craft, which is affixable to the backing.

The term “frame,” as referred to herein means the portion of the art work which surrounds or is contiguous with the representation. The forming medium applied on the backing is arranged such that the frame expresses the art form of the representation and provides another aspect thereof—hereinafter referred to as “expands”—which could not have been conveyed due to the physical limitations of the size of the representation.

By applying forming medium onto an edge of the representation and painting the hardened forming medium in a desired fashion, said edge becomes concealed and consequently indistinguishable from the art form produced from the forming medium applied on the backing. An edge is concealed by means of an art form having the appearance of a frame—hereinafter referred to as a “pseudoframe”—produced by the forming medium applied on the backing, by means of forming medium applied on the representation, or by means of paint applied on the representation, or by a combination thereof.

The composite art work is preferably a continuous work of art formed by a portion of the representation and by a portion of the frame. As referred to herein, a “continuous work of art” means a work of art in which the art form expressed by the representation is expanded to the corresponding frame by drawn lines of the same width and extending in the same direction or in the same pattern, by a similar art style, by a similar color or shade, by a similar texture, or a combination thereof as that of the representation. The frame may duplicate the art style of the representation, which includes, but is not limited by, impressionist, fresco, minimalist and art deco art styles.

The optical effects provided by the composite art work are due to the relative location of the applied forming medium with respect to the representation, as well as to the texturing and thickness of portions of the forming medium.

The hardened forming medium may be coplanar with, or recessed with respect to, the representation. Alternatively, portions of, or the entire hardened forming medium, may protrude from the representation.

In one aspect, the backing is convex.

In one aspect, the art work comprises a plurality of separate art forms. Each adjacent art form is connected by a rod.

Support members are preferably connected to the backing, for separating the backing from the wall on which the composite art work is hung.

The present invention is also directed to a process for producing a composite art work, comprising:
a) adhesively affixing a representation onto a relatively smooth backing;
b) applying a forming medium onto said backing outward of said representation to produce an artistic frame contiguous with said representation;
c) optionally applying a forming medium onto said representation; and
d) painting and/or decorating hardened forming medium whereby a composite continuous work of art is produced by a portion of the representation and by a portion of the frame, said continuous work of art being arranged such that an edge of the representation corresponding to said portion of the representation being substantially indistinguishable from said portion of the frame.

An edge of the representation is concealed by producing a pseudo-frame from forming medium applied on the backing along edges of the representation, by applying forming medium on the representation and painting hardened forming medium such that it expands the art form of the representation, by painting the representation such that it expands the art form thereof, or by a combination thereof.

The texture of the forming medium is produced by inserting at least one artistically significant element into the forming medium and removing said at least one element therefrom so to form a mold from the impression of said at least one element in the forming medium. The at least one artistically significant element may be displaced in a desired fashion before being removed from the forming medium, so as to form a desired texture.

The term “artistically significant element,” as referred to herein, means a solid object of any desired size and shape which is insertable into and removable from forming medium. The configuration of the texture produced by such an element or of the molds produced by a plurality of similar or different elements has artistic significance in expanding the artistic theme expressed in the representation to the frame. Exemplary artistically significant elements are objects smaller than a hand such as a wire, piece of glass, and a leaf, or a portion of a hand-held implement such as a trowel.

Hardened forming medium is painted with at least one layer of paint.

Preferably, lacquer is applied on the external side of the composite work of art, so as to protect it from dirt and fingerprints.

### BRIEF DESCRIPTION OF DRAWINGS

In the drawings:

FIG. 1 is a front schematic view of an exemplary art work produced in accordance with the invention;

FIGS. 2-7 are photographs of other exemplary art works produced in accordance with the invention; and

FIG. 8 is a rear view of an art work produced in accordance with the invention.

### DETAILED DESCRIPTION

The present invention comprises an artistic frame that indistinguishably blends in with an original painting, or a representation thereof, mounted thereby to form a composite, continuous work of art.

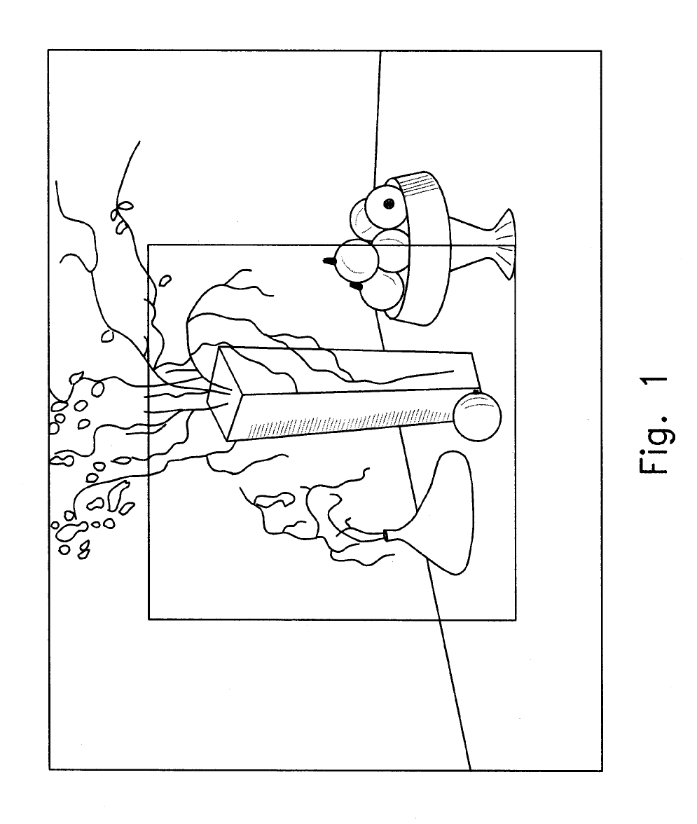

FIG. 1 illustrates an exemplary art work in accordance with the present invention designated generally by numeral 10. Art work 10 comprises centrally disposed artistic representation 5 and artistic frame 7, which surrounds and is contiguous with representation 5. Artistic frame 7, which is considerably wider than frames of the prior art, is produced in such a way, as will be described hereinafter, so as to be formable and capable of being painted. Due to its width, frame 7 may accordingly be painted with sufficient detail, by selected colors and in a desired arrangement, so as to be substantially indistinguishable and furthermore, to blend in with and complete the appearance of the desired art work. The frame may also provide unique optical effects, together with the representation, as will be described hereinafter, which are unknown heretofore in prior art.

Representation 5 is shown to have vases 11 and 12 and fruit stand 14 being placed on table 15. Frame 7 is formed and painted to expand the appearance of representation 5. While the table portion 15 of the representation terminates at edge 9, the table is shown to continue to frame 7, with table edge 13A of the representation being collinear with table edge 13B of the frame. Similarly, stems 16 of the flower growing in vase 12 and fruits 17 are shown to continue to extend to frame 7 in a natural and indistinguishable fashion.

A representation is adhesively affixed by a uniform thickness of adhesive matter, which is applied by means well known to those skilled in the art, on a central portion of a suitable planar surface of a backing, such as wood, canvas or cardboard. After the representation is covered to prevent the discoloring thereof as the frame is being produced, a forming medium, such as modeling paste, e.g. “SuperGamish” produced by Nirlat Ltd., Kibbutz Nir Oz, Israel, or any other viscous material which hardens into a stone-like hardness after being in contact with air, is applied onto the surface, outwardly from the representation. Due to the pastiness of the forming medium, any desired texture or thickness may be produced thereby. After the forming medium dries and hardens, the frame is contiguous with the representation. The hardened forming medium, or a portion thereof, may protrude from, be coplanar with, or be recessed with respect to, the representation. The hardened forming medium is then painted in a certain way so as to present an artistic continuity with, and to expand the art form expressed by, the representation. A portion of the backing may be painted without forming medium first being applied thereon, in order to provide another artistic dimension to the art work. Similarly, paint may be applied directly onto portions of the representation, in order to provide another artistic dimension to the art work.

While the edges of the representation of FIG. 1 are noticeable, art works produced in accordance with the present invention may be made in such a way that the frames are substantially indistinguishable. One technique of making the edges of the representation indistinguishable from the art form presented in the frame is by applying forming medium onto a portion of the frame contiguous with the edges of the representation and producing a pseudo-frame from the forming medium. A border portion is then formed in the frame outwardly from the pseudo-frame, and the pseudo-frame therefore seemingly appears to be hung in the border portion. Other forming material is added to provide the depth perception that the pseudo-frame protrudes from the border portion. The pseudo-frame is textured in such a way which shows that the representation is seemingly mounted therein and that the edges of the representation are covered.

Another technique for making the edges of the representation indistinguishable from the art form presented in the frame involves applying forming medium on the representation. After the forming medium hardens, the hardened forming medium is painted such that a continuous art form is produced which expands the art form of the representation to the frame. Alternatively, paint may be applied onto suitable portions of the representation by a suitable art style and with suitable colors and shades so that the art form expressed by the representation may be expanded to the frame.

A desired texture is produced by inserting an artistically significant element into pasty forming medium. When the artistically significant element is removed from the forming medium immediately following insertion, an impression is formed. A plurality of impressions formed in close proximity one to the other, or in sequential arrangement, provides the texture needed to expand the art form of the representation.

After hardening, e.g. approximately 6-8 hours, the forming medium is painted. When paint is applied by a roller, or by any other suitable means of applying paint by limited pressure, the thickness of the applied paint is reduced and the translucence of the paint layer consequently increases. The optical effect of the work of art may be enhanced by applying several translucent layers of paint, each of which having a different shade. When the underlying forming medium is pigmented, additional optical effects may be produced. Lacquer, e.g. water-based acrylic transparent clear lacquer such as the WATINS-KUX type produced by Oikos, Italy, which is suitable to protect surfaces from dirt, may be added to the art work after the uppermost paint layer dries, e.g. after 4 hours.

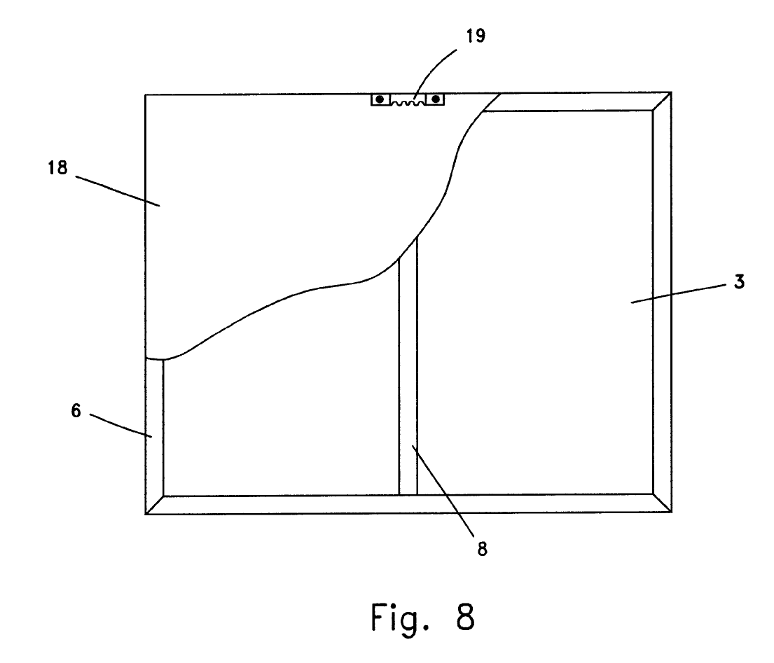

As shown in FIG. 8, support members 6 are connected to the rear of backing 3, around the periphery thereof, with central post 8 connecting two opposed support elements. Support members 6, which are made from e.g. wood or any other suitable structurally strong material, are adapted for separating the backing from the wall on which the composite art work is hung, or from any other surface, in order to prevent deformation of the backing resulting from temperature changes. When more the art work comprises more than one backing member, the support members connect and strengthen the various backing surfaces. Cardboard 18 is added to conceal support members 6, and then hanging element is added to the cardboard.

The advantages of an art work produced in accordance with the present invention include:
1. Expansion of the artistic theme expressed by the reproduction onto the frame.
2. Greater flexibility is afforded an artisan producing an art work by being able to utilize the area of the frame to express an artistic theme.
3. The frame may be contrasted with, or alternatively, blended with, the representation to provide the composite work of art with unique motives or optical effects.
4. Naturally found objects, such as a leaf or flower, industrially produced objects, such as glass, a tile, mirror or a mosaic, three-dimensional objects such as a sculpture, or any hand-made craft may be integrated with the work of art.
5. A plurality of composite art works may be combined to express more detailed and complex themes.
6. The cost of the art work is considerably reduced since a separate frame is unnecessary.
7. The time to produce an art work is reduced since an existing representation may be used as a basis of the art work, rather than having to conceptualize and produce the entire art work.
8. When lacquer is applied to the external side of the art work, its weight is reduced since protective glass for preventing the accumulation of dust and dirt is unnecessary.
9. Without use of protective glass, the appearance of the art work does not change.

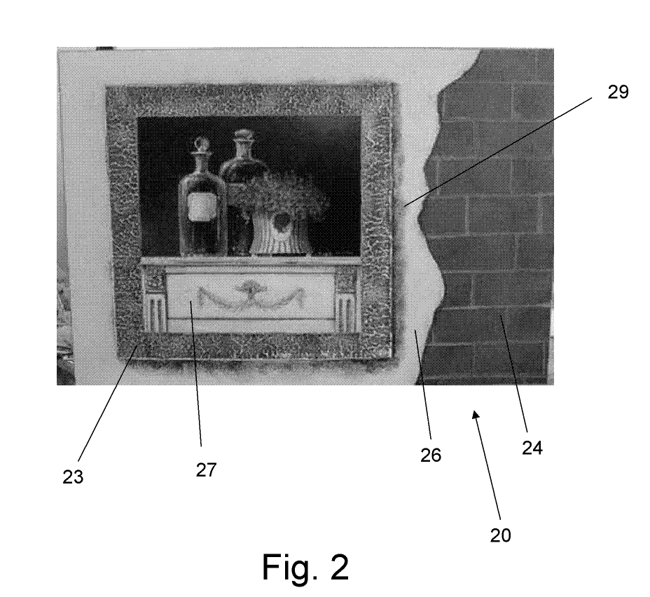

FIGS. 2-6 are photographs of exemplary art works produced in accordance with the present invention.

FIG. 2 illustrates an art work 20 that provides an appearance of a painting having a frame being hung on a brick wall that is not completely painted. In reality, the frame of art work 20 comprises coplanar pseudo-frame portion 23, brick wall portion 24, and painted portion 26. Representation 27 of wine bottles and a vase being placed on a table is adhesively affixed to a planar backing. Pseudo-frame portion 23 is made of a forming medium which is textured with cracks by means of a rounded-head trowel, so as to provide a perception of an antiquated frame. The forming medium is also produced with hair-like elements 29 which extend outwardly from a portion of the periphery of pseudo-frame portion 23, providing a depth perception that representation 27 and frame-like portion 23 are in front of, and hung on, painted portion 26. Hair-like elements 29 are produced by inserting, and removing immediately thereafter, glass strips of 5 cm width into the forming medium. Brick wall portion 24 is painted directly on the backing with acrylic paint. The apparent filling between each brick is made from forming medium which is raised approximately 1 mm above the surface of the bricks. Painted portion 26 is made from paint which is applied directly onto the backing.

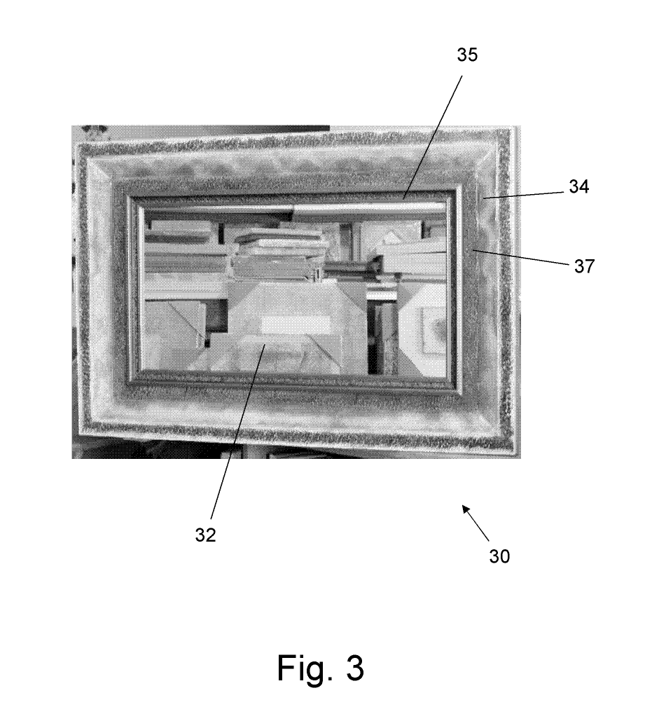

In FIG. 3, art work 30 comprises representation 32 and a double frame having outer layer 34 and inner recessed layer 35. Inner layer frame 35 is a commercially available product. Representation 32 is recessed relative to inner layer 35. Representation 32 is a mirror, which reflects other works of art displayed in a gallery. Outer layer 34 is formed with undulations 37 by means of a spiked trowel. Once the spikes of the trowel are inserted into the forming medium, the trowel is displaced in serpentine fashion to produce the undulations.

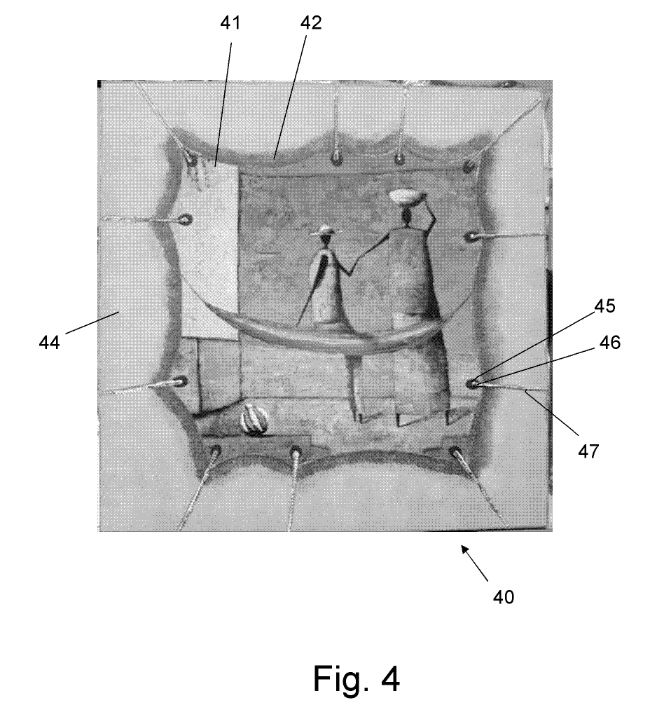

In FIG. 4, art work 40 provides the appearance of an irregular-shaped portrait stretched at its periphery by various cords. The irregular-shape edge of the representation is indicated at 41, and forming medium is applied outwardly of edges 41. Most of the frame is painted brown, while hair-like elements 42 are provided along the periphery of edges 41 and painted white. Holes 45 and cord portion 46 are painted directly on the representation. Cord portion 46 is painted in such a way that it is continuous with cord portion 47 of the frame. Due to the process of producing the art work, the edges of the representation are indistinguishable and the cords appear to extend continuously from the center to the periphery of the art work.

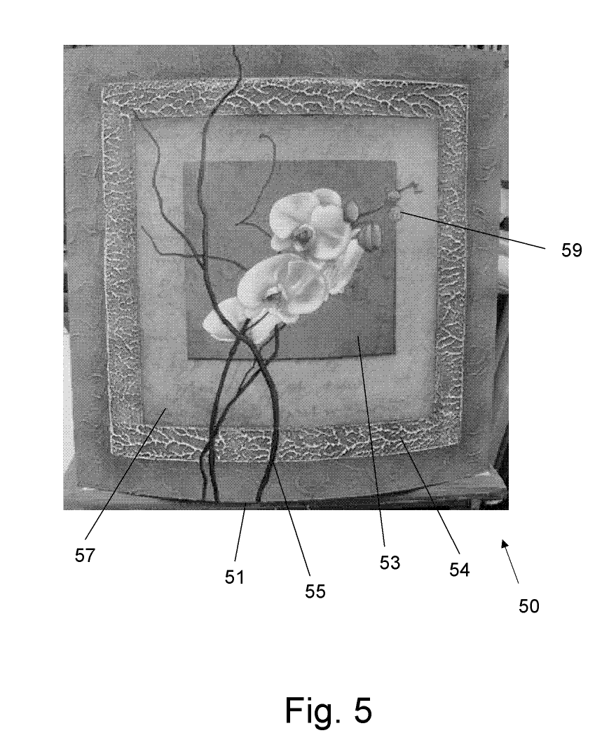

In FIG. 5, the backing of art work 50 is convex, as shown by the rounded bottom edge 51 of the art work. Square representation 53 is adhesively affixed to the center of the backing. Pseudo-frame 54 is made from the modeling paste. Stems 55 are shown to extend from flowers 56 until bottom edge 51, with a portion of pseudo-frame 54 and passe-partout portion 57 prepared and painted to duplicate the stems of the representation, such that the stem portion of the art work frame is indistinguishable from the stem portion of the representation. Bud 59 is painted directly on the representation.

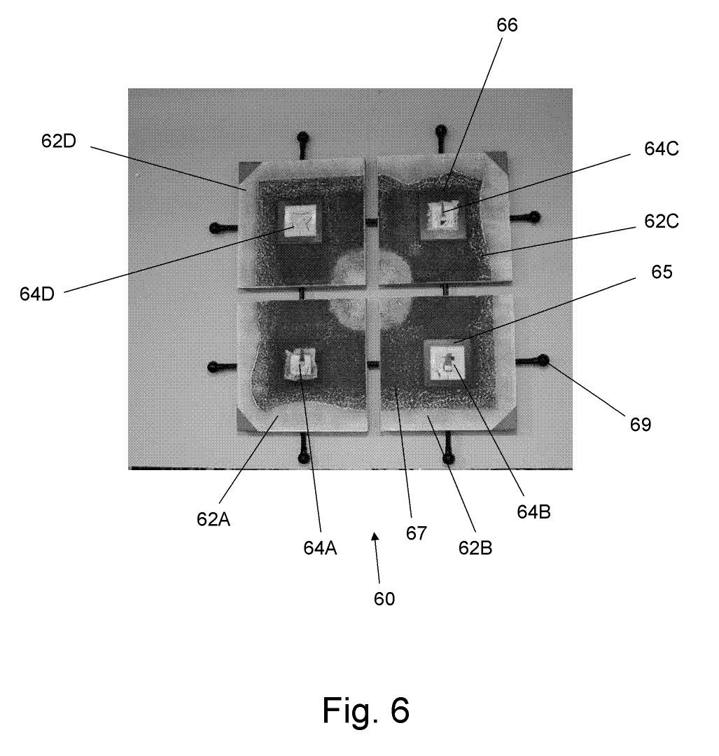

In FIG. 6, art work 60 is made from four separate art forms 62A-D, wherein each art form comprises a representation 64A-D, respectively, adhesively affixed to the backing. Forming medium is applied around each representation to produce a pseudo-frame 65 and a square painting 66. Painting 66 is textured and prepared in such a way that the painting appears to continue from one art form to another, with a circular form 67 produced in the center of painting 66. Rods 69 are used to connect one art form to another.

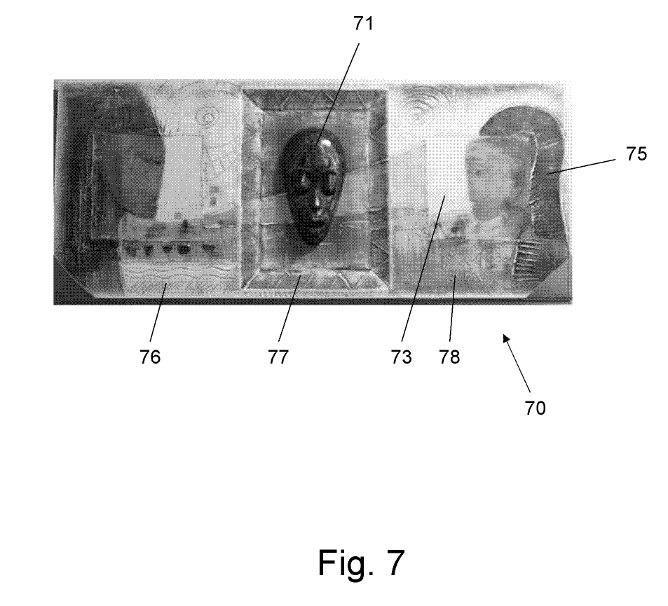

In FIG. 7, art work 70 comprises three art works 76, 77, and 78, which are unified to express a unique artistic theme. Art work 77 comprises representation 71, which is a sculpture. In art work 78, hair 75 is produced from forming medium and expands representation 73 to represent a warrior.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A composite art work, comprising a representation adhesively affixed to a relatively smooth backing and an artistic frame contiguous with the representation, at least a portion of said frame being produced from a forming medium applied to the backing such that edges of the representation are substantially indistinguishable from an art form produced from said forming medium.

2. Composite art work according to claim 1, wherein an art form produced from the frame is shown to be continuously extendible from the representation.

3. Composite art work according to claim 1, wherein the art work is a continuous work of art formed by a portion of the representation and a portion of the frame.

4. Composite art work according to claim 1, wherein an edge of the representation is concealed by means of a pseudo-frame produced by the forming medium applied on the backing.

5. Composite art work according to claim 1, wherein an edge of the representation is concealed by means of forming medium applied on the representation.

6. Composite art work according to claim 1, wherein an edge of the representation is concealed by means of paint applied on the representation.

7. Composite art work according to claim 1, wherein hardened forming medium is coplanar with the representation.

8. Composite art work according to claim 1, wherein hardened forming medium is recessed with respect to the representation.

9. Composite art work according to claim 1, wherein the art work comprises a plurality of separate art forms.

10. Composite art work according to claim 9, wherein each adjacent art form is connected by a rod.

11. Composite art work according to claim 1, wherein the backing is convex.

12. Composite art work according to claim 1, wherein support members are connected to the backing, for separating the backing from the wall on which the composite art work is hung.

13. A process for producing a composite art work, comprising:
adhesively affixing a representation onto a relatively smooth backing;
applying a forming medium onto said backing outward of said representation to produce an artistic frame contiguous with said representation;
optionally applying a forming medium onto said representation; and
painting or decorating hardened forming medium whereby a composite continuous work of art is produced by a portion of the representation and by a portion of the frame, said continuous work of art being arranged such that an edge of the representation corresponding to said portion of the representation being substantially indistinguishable from said portion of the frame.

14. Process according to claim 13, wherein an edge of the representation is concealed by producing a pseudo-frame from forming medium applied on the backing along edges of the representation.

15. Process according to claim 14, wherein an edge of the representation is concealed by applying forming medium on the representation and painting hardened forming medium such that it expands the art form of the representation.

16. Process according to claim 14, wherein an edge of the representation is concealed by painting the representation such that it expands the art form thereof.

17. Process according to claim 13, wherein the texture of the forming medium is produced by inserting at least one artistically significant element into the forming medium and removing said at least one element therefrom so as to form a mold from the impression of said at least one element in the forming medium.

18. Process according to claim 17, wherein the at least one artistically significant element may be displaced in a desired fashion before being removed from the forming medium, so as to form a desired texture.

19. Process according to claim 13, wherein hardened forming medium is painted with at least one layer of paint.

20. Process according to claim 13, wherein lacquer is applied on the external side of the composite work of art.
